(19) United States
(12) Patent Application Publication
(10) Pub. No.: US 2008/0113321 A1
(43) Pub. Date: May 15, 2008

(54) Interactive Electronic Learning System With Tactile Objects

(75) Inventors: Miriam Kelley, Buffalo, NY (US); Brian Aiken, East Aurora, NY (US); Marcia Ganes, West Seneca, NY (US); Aaron Hinklin, Buffalo, NY (US); Justin Petit, Depew, NY (US); Christopher D. Cimerman, Clarence Center, NY (US); Scott H. McIlvain, Holland, NY (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: MATTEL, INC., El Segundo, CA (US)

(21) Appl. No.: 10/598,431

(22) PCT Filed: Mar. 2, 2005
(86) PCT No.: PCT/US05/06620

§ 371 Date: Aug. 14, 2007

Related U.S. Application Data
(60) Provisional application No. 60/549,621, filed on Mar. 2, 2004.
(60) Provisional application No. 60/565,584, filed on Apr. 27, 2004.

(51) Int. Cl. G09B 5/06; G09B 5/00

(52) U.S. Cl. 434/169

(57) ABSTRACT

An interactive learning system has a book, electronic memory, and system electronics. The book has at least one selectable object with a tactile feature. The electronic memory has stored therein data associated with the tactile feature. The system electronics comprises a selection sensor configured to detect the selection of the at least one selectable object, an audio signal generator, and a processor operatively coupled to the electronic memory, the sensor and the audio signal generator. Selection of the tactile feature causes the audio signal generator to produce an audible signal based on the data associated with the tactile feature.

### CROSS-REFERENCE TO RELATED APPLICATIONS

This application is related to U.S. Provisional Patent Application No. 60/549,621, filed Mar. 2, 2004 and U.S. Provisional Patent Application No. 60/565,584, filed Apr. 27, 2004 and claims the earlier filing dates of the provisional applications. Each of the above-identified related applications is incorporated herein by reference.

### BACKGROUND OF THE INVENTION

The present invention relates to an interactive learning system. More particularly, the present invention relates to an interactive electronic learning system for tactile objects that allows a child to activate electronic speech and sounds by selecting objects with tactile features in a book.

The typical interactive electronic learning system comprises one or more books each of which has at least one area of selectable content, non-volatile memory having stored therein material associated with the selectable content, a sensor for identifying a specific selection made from the selectable content and a reader configured to produce an output based on the stored material in response to the selection. The selectable content can include letters, words, graphics and the like. The sensor for selecting the content is typically a stylus or a pressure sensitive switch underlying the selection and the output associated with the selection is typically an audio signal.

The typical interactive, electronic learning systems do not address as subject matter the tactile features of selectable objects in the books intended for use with such systems. An electronic learning system directed to teaching the tactile features of objects within the books intended for use with the system will significantly increase the value of conventional electronic reading aids and, through fun and engaging play, more enjoyably assist a child in developing tactile senses.

### BRIEF SUMMARY OF THE INVENTION

Briefly stated, one embodiment of the present invention is directed to an interactive learning system comprising a book, electronic memory, and system electronics. The book has at least one selectable object with a tactile feature. The electronic memory has stored therein data associated with the tactile feature. The system electronics comprises a selection sensor configured to detect the selection of the at least one selectable object, an audio signal generator, and a processor operatively coupled to the electronic memory, the sensor and the audio signal generator. Selection of the tactile feature causes the audio signal generator to produce an audible signal based on the data associated with the tactile feature.

Another embodiment of the present invention is directed to an interactive learning system comprising a book, a binding, a base unit, electronic memory, and system electronics. The book has a tactile page and a plurality of overlying pages overlying the tactile page. The tactile page has a selectable tactile-page object with a tactile feature. Each overlying page of the plurality of overlying pages has a selectable overlying-page object with a void in register with the tactile feature. The binding connects the tactile page and the plurality of overlying pages. The base unit has a book retainer configured to releasably retain the binding. The electronic memory has stored therein data associated with the tactile feature, the selectable tactile-page object, and each selectable overlying-page object. The system electronics is in the base unit and comprises a sensor assembly configured to sense an identity of the tactile page and each overlying page and to detect the selection of the tactile feature, an audio signal generator, and a processor operatively coupled to the electronic memory, the sensor assembly and the audio signal generator. Selection of the tactile feature when the selectable tactile-page object is viewable causes the audio signal generator to produce an audible signal based on the data associated with the tactile feature and the selectable tactile-page object. Selection of the tactile feature when the overlying page of the plurality of overlying pages is viewable causes the audio signal generator to produce an audible signal based on the data associated with the tactile feature and the selectable overlying-page object.

Another embodiment of the present invention is directed to an interactive learning system comprising a book, a binding, electronic memory, a base unit and system electronics. The book has a first page overlying a second page with a selectable object having a tactile feature. The first page has a void in register with the tactile feature. The binding connects the first page to the second page. The electronic memory has stored therein data associated with the tactile feature. The base unit has a book retainer configured to releasably retain the binding. The system electronics is in the base unit and comprises a selection sensor configured to detect the selection of the tactile feature, an audio signal generator, and a processor operatively coupled to the electronic memory, the selection sensor and the audio signal generator. Selection of the tactile feature causes the audio signal generator to produce an audible signal based on the data associated with the tactile feature.

Another embodiment of the present invention is directed to an interactive learning system comprising a book, a base unit, electronic memory, and system electronics. The book has at least one selectable object with a tactile feature. The base unit has a book well with a book retainer configured to releasably retain the book. The book well has an upwardly facing surface with a plurality of selectable book-well graphics. The electronic memory has stored therein data associated with the tactile feature and the plurality of selectable book-well graphics. The system electronics is in the base unit and comprises a selection sensor configured to detect the selection of the at least one selectable object when the book is releasably retained by the book retainer and to detect selection of one book-well graphic of the plurality of selectable book-well graphics when the book is not in the book well, an audio signal generator, and a processor operatively coupled to the electronic memory, the sensor and the audio signal generator. Selection of the tactile feature causes the audio signal generator to produce an audible signal based on the data associated with the tactile feature. Selection of the one book-well graphic causes the audio signal generator to produce an audible signal based on the data associated with the one book-well graphic.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is digital image of a top plan view of a first preferred embodiment of an interactive learning system in accordance with the present invention;

FIG. 2 is a digital image of a top plan view of the base unit of the interactive learning system of FIG. 1;

FIG. 3 is a schematic block diagram of the system electronics for the interactive learning system of FIG. 1;

FIG. 4 is a digital image of a top plan view of the book in the base unit of the interactive learning system of FIG. 1 open to a two-page spread;

FIG. 5 is a plan view of the layout of another preferred embodiment of a two-page spread for the book in the base unit of the interactive learning system of FIG. 1;

FIG. 6 is a digital image of a preferred embodiment of cards for use in the base unit of the interactive learning system of FIG. 1;

FIG. 7 is a digital image of a top perspective view of a rendering of a removable memory cartridge for use with the base unit of the interactive learning device of FIG. 1;

FIG. 8 is a digital image of a top plan view of the preferred embodiment of the book of the interactive learning system of FIG. 1 showing the book in a closed position;

FIG. 9 is a digital image of a top perspective view of a rendering of the binding of book of the interactive learning device of FIG. 1;

FIG. 10 is a digital image of a top perspective longitudinal view of a rendering of a first half of the binding of the book of the interactive learning device of FIG. 1;

FIG. 11 is a digital image of a top perspective longitudinal view of a rendering of a second half of the binding of the book of the interactive learning device of FIG. 1;

FIG. 12 is a digital image of a top perspective view of a rendering of the retainer in the base unit for the binding of the book of the interactive learning device of FIG. 1;

FIG. 13 is a digital image of a top perspective longitudinal view of a rendering of a retainer plate for the interactive learning device of FIG. 1; and

FIG. 14 is a digital image of a bottom perspective longitudinal view of a rendering of the retainer plate of FIG. 13 mounted to the bottom side of the book well of the interactive learning device of FIG. 1.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the interactive learning system, and designated parts thereof. The terminology includes the words noted above, derivatives thereof and words of similar import.

The term “book” as used in the claims and in corresponding portions of the specification includes not only conventional books, but also other forms of printed information that could be read directly by the viewer including, but not limited to, maps, posters, cards, newspapers and other unbound publications, and magazines.

Referring to the drawings in detail, where like numerals indicate like elements throughout, there is shown in FIGS. 1-3 a first preferred embodiment of the interactive learning system, generally designated 10, and hereinafter referred to as the “learning system” 10 in accordance with the present invention. In general, the learning system 10 is an interactive electronic learning system for teaching, among other things, tactile features of various objects by allowing a child to activate electronic speech by selecting words or objects on the cover and pages of multi-page books. The learning system 10 comprises a book 12, electronic memory 14, and system electronics 16.

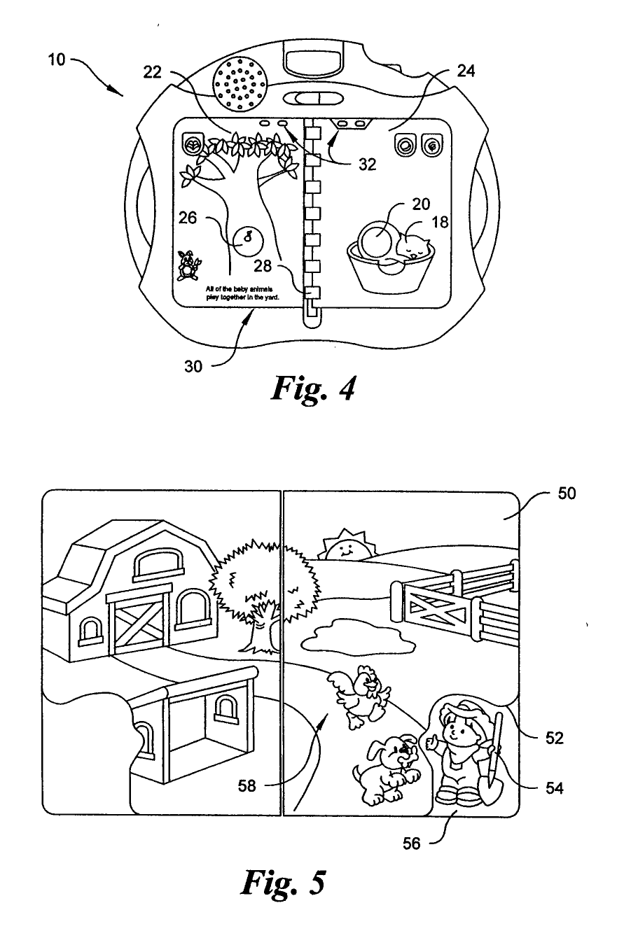

The book 12 has at least one selectable object 18 (FIG. 4) with a tactile feature 20. Preferably, the book 12 has a first page 22 overlying a second page 24. The second page 24 has the at least one selectable object 18 thereon. The first page 22 has a void 26 in register with the tactile feature 20 when the first page 22 is overlying the second page 24 The first page 22 and the second page 24 are connected by a binding 28 further disclosed below. The first page 22 is movable from a first position (FIG. 1) overlying the second page 24 to a second position (FIG. 4) in which the first page 22 and the second page 24 form a two-page spread 30. The two-page spread 30 may have an identification code 32 uniquely identifying the two-page spread 30. Preferably, the identification code 32 is an optical code.

In addition to the second page (or tactile page) 24, the book 12 may have a plurality of overlying pages overlying the tactile page 24. As discussed above, the tactile page (or second page) 24 has a selectable tactile-page object 18 with the tactile feature 20. Each overlying page (or first page) 22 of the plurality of overlying pages has a void 26 in register with the tactile feature 20 when the overlying page 22 is overlying the second page 24. The void 26 on each overlying page 22 may be associated with the selectable overlying-page object 34 such that the tactile feature 20 may be a feature of the selectable overlying-page object 34.

For example, referring to FIG. 4, the tactile page 24 is the right page of the two-page spread 30. The selectable tactile-page object 18 is a kitten sleeping in a basket. The tactile feature 20 is generally circular-shaped patch of fur within the boundary of the kitten's body. Referring to FIG. 1, when the overlying page 22 overlies the tactile page 24, the patch of fur (or tactile feature) 20 on the tactile page 24 lies within the boundary of the bunny's body and is selectable through the void 26.

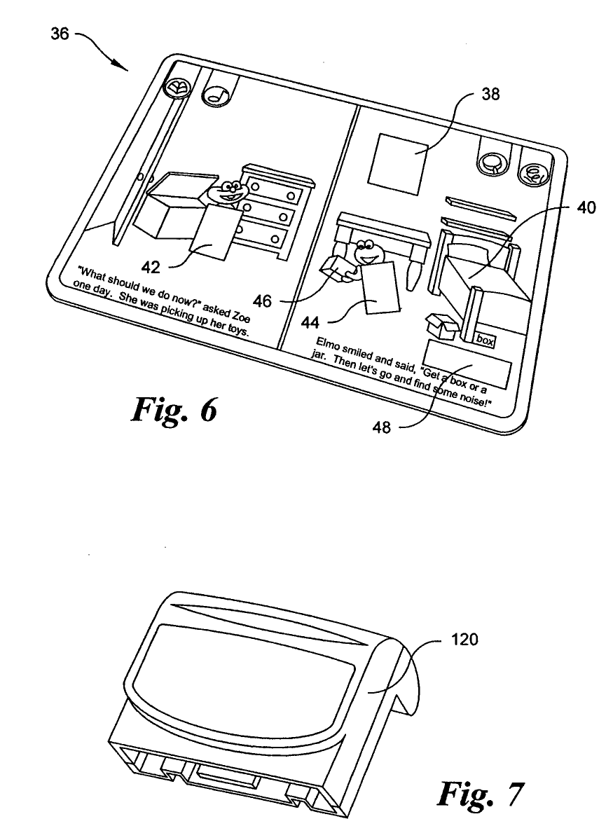

In addition to being formed by the first page 22 and the second page 24, the two-page spread 30 may be a single sheet such as the cards 36 shown in FIG. 6. The layouts appearing on the two-page spread 30, whether the two-page spread 30 is formed from a first page 22 and second page 24 or has the configuration of the card 36, preferably, but not necessarily, include one or more selectable objects having some tactile feature in addition to selectable objects without a tactile feature. For example, referring to FIG. 6, the picture frame 38, the bed spread 40, Zoe's body 42 and Elmo's body 44 have fabric overlays with a different texture. The tactile features are not limited to fabric textures, and may include other textures such as the cardboard texture of the block box 46 and the wood texture of the wooden box 48 also appearing in FIG. 6. The tactile features are not limited to the above examples and may include features associated with any known material or selectable object such as raised printing, stickers and embossed stickers, paper including sand paper and foil paper. Topographical textural features associated with molded polymeric materials also are included within the meaning of the phrase “tactile features”.

A tactile feature associated with a selectable object appearing on a two-page spread or a card may be accessible only when the two-page spread or card on which the tactile feature appears is viewable. Alternatively, the selectable object may be accessible when two-page spreads or cards other than the page spread or card on which the tactile feature appears is viewable. For example, referring to FIG. 5, an overlying first two-page spread 50 has a cut-out 52 in the lower right corner, allowing the graphic of a farmer 54 on a second page spread 56 underlying the first two-page spread 50 to be accessible when the first two-page spread 50 is viewable. Accordingly, tactile features, if any, associated with the graphic of the farmer 54 may be selectable at times other than when the second page spread 56 is viewable in its entirety. In contrast, absent a cut-out on a two-page spread immediately overlaying the first two-page spread 50, graphics of the animals 58 appearing on the first page spread 50 are only viewable when the first page spread 50 is viewable.

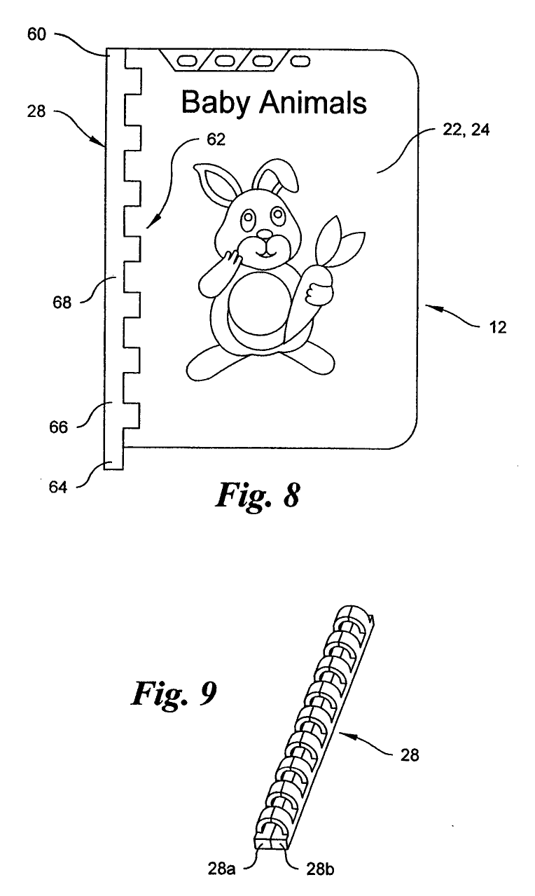

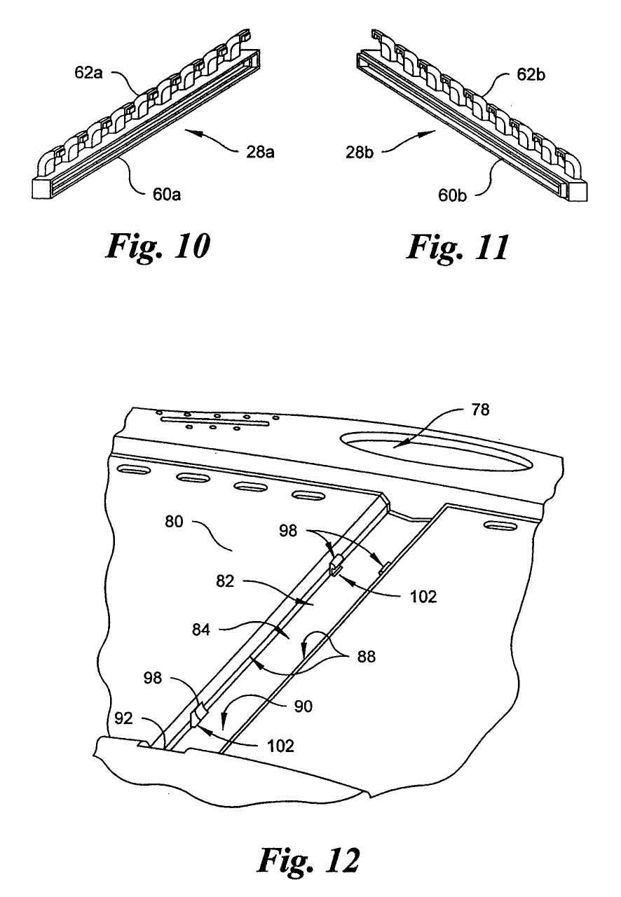

Referring to FIGS. 8-12, there is shown a preferred embodiment of the binding 28 connecting the tactile page 24 and the plurality of overlying pages 22. The binding 28 comprises an elongated binding base 60 having a plurality of rings 62 engaging the tactile page 24 and the plurality of overlying pages 22. The elongated base 60 has a tab 64 at one end and first and second outwardly facing side surfaces 66 with a slot 68. The binding 28 (FIG. 9) has a generally D-like cross sectional shape and may be formed by a first half 28a (FIG. 10) and a second half 28b (FIG. 11), each of which has a binding base 60a, 60b and a plurality of partial rings 62a, 62b configured to join in a tongue and groove like manner to form the D-shaped binding 28. The joining of the first and second halves 28a, 28b of the D-shaped binding 28 may be by a friction fit, by an adhesive bond, by thermal fusion or by any other well known method. The D-shaped binding 28 is preferably a polymeric material. Alternatively, the binding 28 may be formed from a metal or other suitable material. Although the above D-shaped binding 28 is preferable, the binding 28 also may have other well known configurations, such as a spiral binding, without departing from the spirit and scope of the present invention.

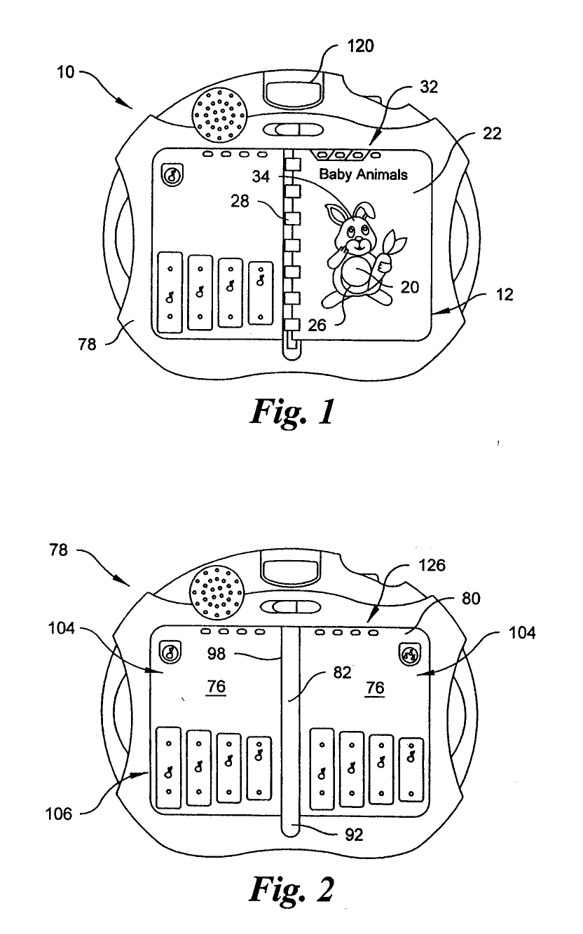

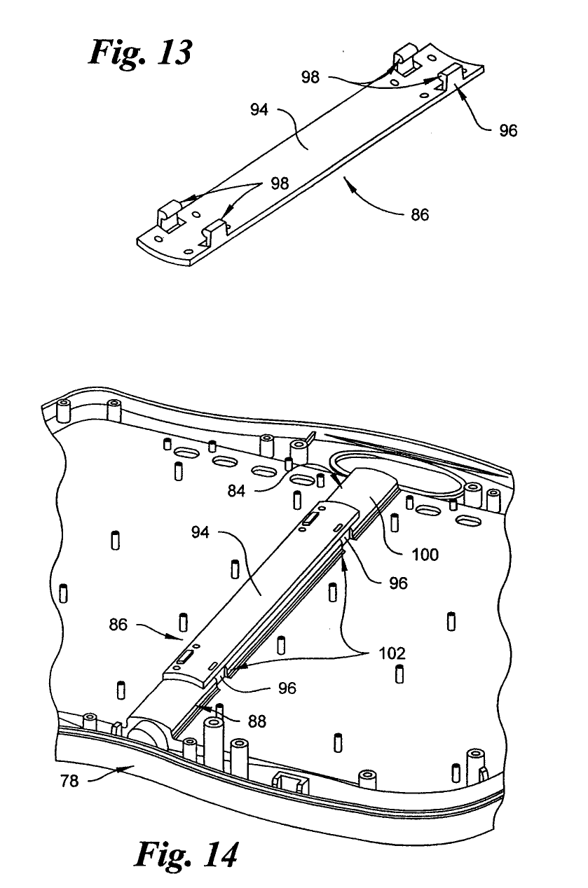

Referring to FIGS. 2 and 12-14, a base unit 78 is provided for housing the system electronics 16 and for supporting the book 12. The base unit 78 preferably, but not necessarily, has a book well 80 with a book retainer 82 configured to releasably retain the binding 28 of the book 12. The book retainer 82 comprises a binding receiving slot 84 formed in the book well 80 and a retainer plate 86 (FIGS. 13-14). The binder receiving slot 84 has opposed side walls 88, a slightly concave shaped bottom portion 90, and a detent 92 at one end. The detent 92 is configured to receive the tab 64 (FIGS. 1, 8) of the book binding 28.

The retainer plate 86 comprises a generally rectangular-shape retainer base 94 configured to conform to the slightly concave shape of the bottom portion 90 of binding receiving slot 84. A pair of opposed and spaced-apart retainer arms 96 are positioned proximal to each end of the retainer base 94 and extend upwardly. The end of each retainer arm 96 distal to the retainer base 94 has an inwardly extending tang 98. The retainer arms 96 are elastically compliant and exert an inwardly directed reactive force when displaced outwardly. Preferably, the retainer plate 86, including the retainer base 94 and the retainer arms 96, is a polymeric material. Alternatively, the retainer plate 86 can be other well known material such as metal suitable able to perform the disclose function.

Referring to FIGS. 12 and 14, the retainer plate 86 is positioned adjacent the under side 100 of the bottom portion 90 of the binding receiving slot 84 such that the retainer arms 96 extend into corresponding retainer slots 102 in the side walls 88 of the binding receiving slot 84 and the tangs 98 of the retainer arms 96 project into the binding receiving slot 84 for a snap-fit insertion into the corresponding slots 68 in the first and second outwardly facing side surfaces 66 of the elongated binding base 60 when the binding 28 is inserted in the binding receiving slot 84.

Preferably, the retainer base 94 is adhesively attached to the under side 100 of the bottom portion 90 of the binding receiving slot 84. Alternatively, the retainer base 94 can be attached by other well known methods such as fusion bonding or with conventional mechanical fasteners, including screws, rivets and the like.

Referring to FIG. 2, the book well 80 has a recessed, upwardly facing surface 76 that may have a plurality of selectable book-well graphics 104 thereon. Alternatively, the book well 80 may be replaced by a planar surface that is not recessed. The selectable book-well graphics 104 allow book-well based game play when a book is not present in the book well 80. The book-well graphics 104 may include selectable keys 106 and instrument graphics 108. Preferably, the selectable keys 106 simulate an eight-key musical keyboard and allow a child to play a scale of an instrument such a xylophone. Scales related to other musical instruments can be activated by selecting the corresponding instrument graphic 108. In alternative embodiments, book-well based game play may be directed to other activities with corresponding selectable graphics, such as alphabet-based game play.

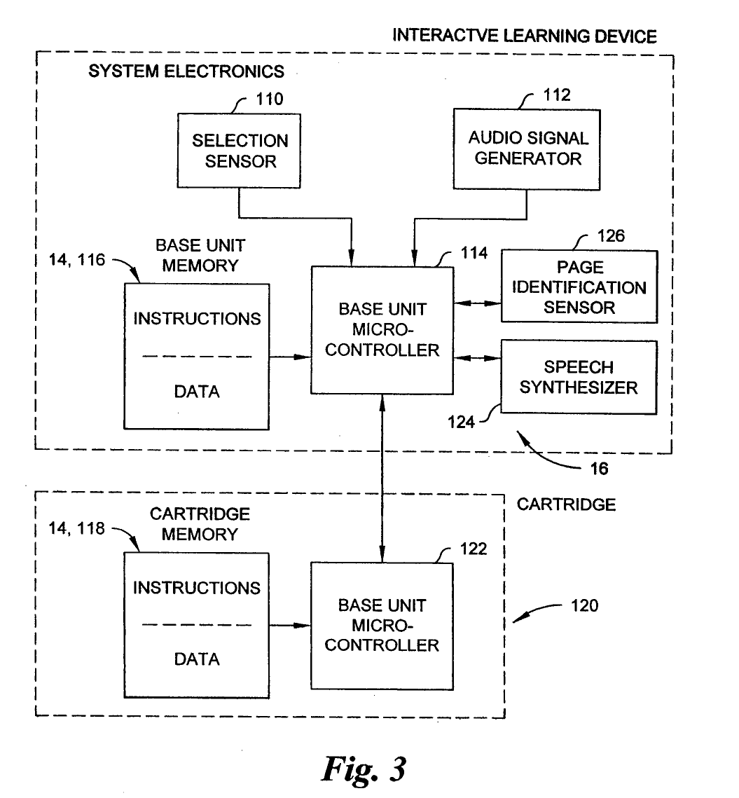

Referring to FIG. 3, the system electronics 16 in the base unit 78 comprises a selection sensor 110 and an audio signal generator 112 operatively coupled to a processor (or base unit microcontroller) 114. The processor 114 is also operatively coupled to the electronic memory 14 which may include base unit memory 116 in the base unit 78, cartridge memory 118, or both. The cartridge memory 118 is housed in a removable cartridge 120 (FIG. 7) that may also include a cartridge microcontroller 122. The system electronics 16 may also include a speech synthesizer 124 and an identification code detector (or page identification sensor) 126 operatively coupled to the processor 114. The identification code detector 126 and the selection sensor 110 may be arranged as an sensor assembly configured to sense an identity of the tactile page 24 and each overlying page 22 and also detect the selection of the tactile feature 20 on the tactile page 24.

The general functionality of the base unit 78 and the electronics in the base unit 78 are substantially the same as the functionality and electronics disclosed in detail for the base unit in pending U.S. Non-Provisional patent application Ser. No. 10/448,583 filed May 30, 2003 and entitled “An Electronic Learning Device For An Interactive Multi-Sensory Reading System” (U.S. Patent Application Publication No. US 2004-0043365 A1), and incorporated herein by reference.

The selection sensor 110 is configured to detect selection of the tactile feature 20 of the at least one selectable object (or tactile page object) 18. The selection sensor 110 also may detect selection of the overlying page object 34 and selection of one book-well graphic of the plurality of selectable book-well graphics 104 when the book 12 is not in the book well 80. The selection sensor 110 may be any well known sensor, such as pressure sensitive membranes or switches commonly used in interactive electronic reading devices. The selection sensor 110 may be a position sensor configured to communicate to the processor 114 the location of the tactile feature 20 on the two-page spread 30 when the book 12 is in the book well 80. A stylus based position sensor such as the electrographic sensor disclosed in U.S. Pat. No. 5,686,705 may also used for the selection sensor 110. Preferably, the selection sensor 110 is configured for selection of an object without a stylus, such as selection by touching the object with a finger, and is substantially the same as the sensor disclosed in detail in U.S. Non-Provisional patent application Ser. No. 10/448,582 filed May 30, 2003 and entitled “Interactive Multi-Sensory Reading System Electronic Teaching/Learning Device” (U.S. Patent Application Publication No. US 2004-0043371 A1). The disclosures of both U.S. Pat. No. 5,686,705 and U.S. Patent Application Publication No. US 2004-0043371 A1 are incorporated herein by reference.

The identification code detector 126 is configured to send to the processor 114 a signal representing the identification code 32 appearing on the two-page spreads 30. Preferably, the identification code 32 is an optical code and the identification code detector 126 is an optical sensor configured to irradiate the optical code and send to the processor 114 a signal representing the optical code. Various well known encoding schemes and detection and decoding systems may be used. The preferred encoding scheme and detection and decoding system is the autonomous optical page identification system disclosed in detail in U.S. Non-Provisional patent application Ser. No. 10/767,321 filed Jan. 29, 2004 and entitled “Interactive Electronic Device with Optical Page Identification System” (U.S. Patent Application Publication No. US 2004-0213140 A1) and incorporated herein by reference.

The interaction between a user and the learning system 10 is script based. The electronic memory 14 stores the instructions and data associated with the content of the book 12 and with the script for the book 12. As the electronic memory 14 may include both the base unit memory 116 and the removable cartridge memory 118, the instructions and data associated with the script for the book 12 may be stored in either the base unit memory 116 or the removable cartridge memory 118. Further, a library of supplemental books (not shown), each associated with a cartridge, such as the cartridge 120 removably insertable in the base unit 78 allow for an ever expanding scope for book and script content and for various modes of operation for the learning system 10.

Any and all of the modes of operation (story, word, spelling, phonics, surprise, find, count, and music) discussed in pending U.S. Non-Provisional patent application Ser. No. 10/448,583, incorporated by reference above, are available to the script writer. In addition, new modes, the instructions for which may be stored in the removable ROM cartridges associated with the supplemental books and cards, may provide additional functionality for the learning system 10. The typical interaction relating to the tactile features of one or more of the associated selectable objects includes but is not limited to the following: a non-prompted touch of an object having a tactile feature may cause the learning system 10 to produce an attribute associated with the object as an audible output, (e.g., a meow, if the tactile feature is a fur spot of a kitten) or, alternatively, an audible output associated with the tactile feature (e.g., I have fur, if the fur spot of the kitten is touched). Prompted interactions include such prompts as “touch something furry” followed by a positive acknowledgement if the fur spot of the kitten is touched. If an incorrect selection is made an output representative of the incorrect selection may be output. A hint for a next attempt may also be provided.

More specifically, in various embodiments of the learning system 10, the selection of a tactile feature may have at least one of the following effects.

The selection of the tactile feature may cause the audio signal generator 112 to produce an audible signal based on the data associated with the tactile feature.

The selection of the tactile feature when the tactile page is viewable may cause the audio signal generator 112 to produce an audible signal based on the data associated with the tactile feature and the selectable tactile-page object.

The selection of the tactile feature when one overlying page of the plurality of overlying pages is viewable may cause the audio signal generator 112 to produce an audible signal based on the data associated with the tactile feature and the selectable overlying-page object. For example, Referring to FIGS. 1 and 4, upon selection of the kitten (FIG. 4), the word “kitten” may be spoken by the learning system 10. Upon section of the patch of fur, the statement “a kitten is furry” may output. The selectable overlying-page object 34 on the overlying page 22 is a bunny (FIG. 1). Upon selection of the bunny, the word “bunny” may be spoken. Upon selection of the patch of fur, accessible through the void 26, the statement “baby bunnies are soft” may be output.

The selection of the one book-well graphic may cause the audio signal generator to produce an audible signal based on the data associated with the selected book-well graphic.

From the above disclosure, the artisan will understand that a user's interaction with tactile features is script based and directed to providing the user with either an entertaining or learning experience by providing the capability for exploring various aspects of the sense of touch with an interactive electronic book system. Accordingly, there is no limit intended on the nature of the interaction provided.

Those skilled in the art will appreciate that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An interactive learning system comprising:
a. a book having at least one selectable object with a tactile feature;
b. electronic memory having stored therein data associated with the tactile feature;
c. system electronics comprising:
i. a selection sensor configured to detect the selection of the tactile feature;
ii. an audio signal generator; and
iii. a processor operatively coupled to the electronic memory, the sensor and the audio signal generator,
wherein selection of the tactile feature causes the audio signal generator to produce an audible signal based on the data associated with the tactile feature.

2. The interactive learning system according to claim 1, wherein the book has a first page overlying a second page having the at least one selectable object, the first page having a void in register with the tactile feature.

3. The interactive learning system according to claim 2, wherein the first page and the second page are connected by a binding, and the first page is movable from a first position overlying the second page to a second position in which the first page and the second page form a two-page spread.

4. The interactive learning system according to claim 3, wherein the two-page spread has an identification code and the system electronics further comprises a identification code detector configured to send to the processor a signal representing the identification code.

5. The interactive learning system according to claim 4, wherein the identification code is an optical code, and the identification code detector is an optical sensor configured to irradiate the optical code and send to the processor a signal representing the optical code.
